(19) United States
(12) Patent Application Publication
(10) Pub. No.: US 2016/0167351 A1
(43) Pub. Date: Jun. 16, 2016

(54) FILM FOR PROTECTING AN OBJECT DURING TREATMENT AND USE THEREOF

(71) Applicant: MONDI Gronau GmbH, Gronau (DE)

(72) Inventors: Matthias PERICK, Ahaus-Alstaette (DE); Matthias WIGGER, Gronau (DE); Frank WIDEY, Legden (DE)

(21) Appl. No.: 14/966,126

(22) Filed: Dec. 11, 2015

(30) Foreign Application Priority Data
Dec. 11, 2014 (EP) 14197407.1

(51) Int. Cl. B32B 27/32; B32B 27/18; B32B 27/08

(52) U.S. Cl. CPC B32B 27/32; B32B 27/08; B32B 27/18; B32B 2264/102; B32B 2264/10

(57) ABSTRACT

A surface-protection film has a first outer face normally applied to an object, a first outer layer forming the first outer face and including titanium-dioxide particles and 0 wt.-% to 0.05 wt.-% carbon black, and a second outer face opposite the first outer face and having a brightness value L* of greater than 85 at a measurement angle of 10° and a CIE standard illumination D65.

### FIELD OF THE INVENTION

The present invention relates to a surface-protection film. More particularly this invention concerns such a film for protecting an object during treatment of the object. The invention accordingly also relates to the use of the surface-protection film for the temporary protection of an object during the processing thereof.

### BACKGROUND OF THE INVENTION

A typical protective film has a first outer face that is provided for application to an object, a second outer face, and at least one film layer forming the first outer face and containing an additive absorbent in the near infrared and a white batch containing titanium dioxide. Such a surface protective film is provided in particular for temporary protection of the object, for example during processing.

In particular, the temporary surface-protection film is to be cut with the object to be protected by a laser. In this case, the surface-protection film has to be able to be cut in a sharply contoured and clean manner by the laser radiation used.

In practice, CO₂ lasers and solid-state lasers are frequently used. Standard solid-state lasers include fiber lasers in which the active medium is a doped core of a glass fiber, and the fiber laser also has the properties of an optical waveguide. A further solid-state laser that is frequently used in practice is the Nd:YAG laser.

Whereas a carbon-dioxide (CO₂) laser emits radiation in the middle infrared range having a wavelength of 10.6 μm, the typical solid-state lasers, including the above-mentioned fiber laser and Nd:YAG laser, emit radiation in the near infrared range, in particular at a wavelength of 1064 nm. The near infrared range refers in practice to the wavelength range from 780 nm to 3 μm, and the spectral range IR-A having a wavelength of 780 nm to 1.4 μm (compare DIN 5031, part 7) is particularly relevant for the described solid-state lasers.

Typical plastics, such as the polyolefins that are preferably used for surface-protection films, are transparent in the range of the near infrared and in particular in the spectral range IR-A, but are absorbent in the middle infrared range and in particular at the wavelength of the CO₂ laser.

To also enable absorption in the near infrared range and therefore a universal usage of the surface-protection film, carbon black particles are added to the plastic as an absorber. As a result, the film, because of the absorption by the carbon black in the visible range, is also black or, if a white batch is added, is at least gray.

This is disadvantageous insofar as the usage possibilities are restricted with regard to printing the surface-protection film with instructions, markings, or advertisements and with respect to a high-quality appearance of the surface-protection film.

To reduce these disadvantages, multilayer surface-protection films are known that, by varying the quantity of carbon black and the addition of a white batch, are embodied as dark toward the object to be protected and lighter on the opposite outer side. Thus, a surface-protection film having the features of the preamble is known from EP 2 679 332 A1, and the side of the protection film to be placed on the object is provided with a pressure-sensitive adhesive. According to all illustrated embodiments, a three-layer film based on LDPE is described, and a first film layer that is oriented toward the object comprises carbon black having a weight fraction of 1 wt.-% as an additive absorbent in the near infrared. Furthermore, an intermediate layer is provided that can also contain titanium dioxide as an absorber in addition to carbon black, while a second outer layer comprises titanium dioxide having an increased fraction and preferably free of carbon black. Although the second outer layer contains titanium dioxide, the surface-protection film has a lesser degree of whiteness because of the other dark layers.

The color space standard L*a*b* that was developed by the CIE (Commission Internationale de L'eclairage—International Commission on Illumination), is determined as the measure of brightness. This color space that is also referred to as CIELAB, is the subject matter of DIN EN ISO 11664-4 that replaces DIN 6174 that was withdrawn in 2011. The determination of the parameters L*, a*, and b* can be performed using typical chromatometers.

According to EP 2 679 332, the first outer face in all illustrated embodiments is dark gray and has a brightness value L* between 22 and 27. The second outer face that is turned to the outside after application of the film to an object to be protected, has a higher brightness L* between 45 and 72 (see Tables 1 and 2). The optical appearance is in need of improvement because of the dark colored layers.

### OBJECTS OF THE INVENTION

It is therefore an object of the present invention to provide an improved film for protecting an object during treatment.

Another object is the provision of such an improved film for protecting an object during treatment that overcomes the above-given disadvantages, in particular that can be cut using a laser both in the near infrared range and also in the middle infrared range and has improved optical properties in the visible range.

### SUMMARY OF THE INVENTION

A surface-protection film has according to the invention a first outer face normally applied to an object, a first outer layer including titanium-dioxide particles, 0 wt.-% to 0.05 wt.-% carbon black, and an additive absorbent in the near infrared. A second outer face opposite the first outer face has a brightness value L* of greater than 85 at a measurement angle of 10° and a CIE standard illumination D65.

The present invention relates in particular to a surface-protection film with no dark layers. The surface-protection film can fundamentally be embodied as a monofilm, but a multilayer construction, in particular a three-layer construction is preferred, however.

The surface-protection film is preferably not only light, but rather also not substantially colored. Thus, according to one preferred embodiment of the invention, the absolute value of the color values a* and b* that are determined on the second outer face at a measurement angle of 10° and a CIE standard illumination D65, is less than 10, preferably less than 5, and in particular less than 2.5.

The total thickness of the surface-protection film can be between 40 μm and 150 μm, in particular between 60 μm and 90 μm.

The surface-protection film can be provided with a coating, for example, an adhesive, on the first outer layer for application to the object. The surface-protection film is preferably embodied without such a coating having an adhesive, however, and adheres solely because of the surface composition of the first outer face, for which purpose it can be particularly glossy and/or can be provided with a surface treatment, for example.

The first film layer can comprise polyethylene, including a polyethylene mixture, as the main component. The fraction of polyethylene in the first film layer can be greater than 70 wt.-%, in particular between 80 wt.-% and 90 wt.-%, and polyethylene can be provided as the only polymer component of the first film layer except for the absorbent additive and the white batch.

If the surface-protection film is a laminate according to a preferred embodiment, all layers can comprise polyethylene as the main component in the described manner.

In a multilayer construction, there is at least a second film layer and optionally further film layers that also have a white batch that contains an additive absorbent in the near infrared and titanium dioxide, and the second film layer and optionally further film layers contain less than 0.05 wt.-%, in particular less than 0.01 wt.-% carbon black and are preferably free of carbon black. The entire surface-protection film is particularly preferably free of carbon black, so that nothing is lost even when looking through lower-lying film layers.

According to the invention, the fraction of titanium dioxide in the first film layer and, in a laminate, preferably in all film layers can be between 3 wt.-% and 12 wt.-%, particularly preferably between 5 wt.-% and 10 wt.-%. An effective white coloration can be achieved by the described fraction of titanium dioxide.

In addition, it has surprisingly been shown on the basis of orienting experiments that titanium dioxide can also particularly advantageously have an effect on the ability to cut the surface-protection film by lasers, although titanium dioxide, because of the white color, is not absorbent in the near infrared range, in particular in a range around 1064 nm.

However, it is assumed that the titanium dioxide particles can typically refract and deflect to a certain extent laser radiation that is incident perpendicularly, so that an increased probability of absorption then results with respect to the additive absorbent in the near infrared.

In this context, it is also assumed that the size and size distribution of the titanium dioxide particles is also significant in the interaction with the absorbent additive. Thus, according to one preferred embodiment of the invention, in at least the first film layer and with a multilayer construction preferably in all film layers, the weight fraction of the titanium oxide particles, with respect to the total amount of the titanium dioxide contained in the respective film layer, having a size standardized to a volume-equivalent sphere diameter between 400 nm and 700 nm is greater than 50%. The individual titanium-dioxide particles then have a size in a large fraction that corresponds to approximately half of the wavelength when measured via a wavelength of 1064 nm and can therefore cause refraction of the laser beam to a particular extent.

According to the invention, a particularly light film is provided that preferably comprises exclusively light, essentially white film layers. Against this background, an additive absorbent in the near infrared is to be used that, in contrast to the typical additive carbon black, does not cause dark coloration. An additive also referred to as a laser master batch is preferably used that contains inorganic particles at a fraction between 1 wt.-% and 5 wt.-%, particularly preferably between 1 wt.-% and 3 wt.-%, and the mentioned weight fraction relates to the total weight of the respective associated film layer. In a laminate, all film layers are preferably provided with the specified quantity of inorganic particles as a component of the absorbent additive.

For example, mica is suitable as inorganic particles of the additive absorbent in the near infrared, and the individual mica particles can be coated with metal oxide.

According to a further aspect of the invention, the entire surface-protection film is formed from polyethylene, the white batch containing titanium dioxide, and the additive absorbent in the near infrared that is free of carbon black. Thus, except for the white batch and the laser master batch as the absorbent additive, an unmixed or essentially unmixed surface-protection film is thus provided that can also be recycled well. For example, if the film is used as recycled material, the functional components of the white batch and the laser master batch generally do not have a negative effect. As is typical, processing agents can still be contained in the surface-protection film, and the fraction is generally less than 2 wt.-%, however.

A laminate of the surface-protection film is also advised in the case of a substantially unmixed embodiment, however, to be able to use different polyethylene types or different polyethylene mixtures for the various layers for a functional adaptation of the surface-protection film. Low-density polyethylene (LDPE) is preferably used for the two outer layers. A mixture of various polyethylene types, for example, low-density polyethylene (LDPE) and linear low-density polyethylene (LLDPE) comes into consideration in particular for the core layer. A mixture of medium-density polyethylene (LDPE) with a medium-density polyethylene obtained using metallocene catalysts (mMDPE) is also suitable for the core layer, for example.

The subject matter of the invention is also the use of the surface-protection film for the temporary protection of an object during the processing thereof, and the surface-protection film is applied with the first side on at least one section of the object, and subsequently the exposed second outer face of the surface-protection film is impinged by laser radiation having a wavelength in the near infrared or middle infrared range, and the surface-protection film and the object arranged underneath are cut by the laser radiation. The object can be a layer material, in particular a metal plate.

Because the surface-protection film has a high brightness value L* of greater than 85, a particularly high-quality impression results, and imprints, markings, or the like can also be seen particularly well on the second outer face.

The object is typically provided with openings and/or with an external shape cut by the laser. For example, metal plates can be cut to size in a predefined shape, and then the surface-protection film is still present on the object to be protected and is only pulled off thereafter. Since the surface-protection film can be cut precisely using the laser, a sharp, precise separation also results, so that the edges of the object to be protected can also still be well protected at the cut line.

The surface-protection film is typically produced by extrusion, in a laminate by coextrusion. A particularly glossy and clingy surface on at least one of the two outer sides can be produced by a cast extrusion with subsequent smoothing on a chilled roller and/or a smoothing belt. However, blow film extrusion or coextrusion also comes into consideration for the production of the surface-protection film, and generally lower production costs result. The first outer face provided for application to the object can also be provided with a surface treatment, a coating, or adhesive to improve adhesion. The surface-protection film is typically made so that it can also be pulled off without residue after the protected object has been cut to size, and polyethylene as a tough material is particularly suitable also in this context.

Additives that are suitable in the scope of the invention and are absorbent in the near infrared that can also be referred to as a laser master batch, are sold, for example, by Treffert GmbH & Co. KG from D-55411 Bingen, Germany under the designations HT-MAB PE 91131 LSA and HAT-MAB PE 91095. The mentioned additives have a fraction of inorganic substances of approximately 40%.

In the scope of orienting experiments, “White PE MB 11989-I” from Ampacet was used as a white batch containing titanium dioxide.

### BRIEF DESCRIPTION OF THE DRAWING

The above and other objects, features, and advantages will become more readily apparent from the following description, reference being made to the accompanying drawing in which:

FIG. 1 is a large-scale schematic section through a first embodiment of the invention; and

FIG. 2 is a view like FIG. 1 of a second embodiment of the invention.

### SPECIFIC DESCRIPTION OF THE INVENTION

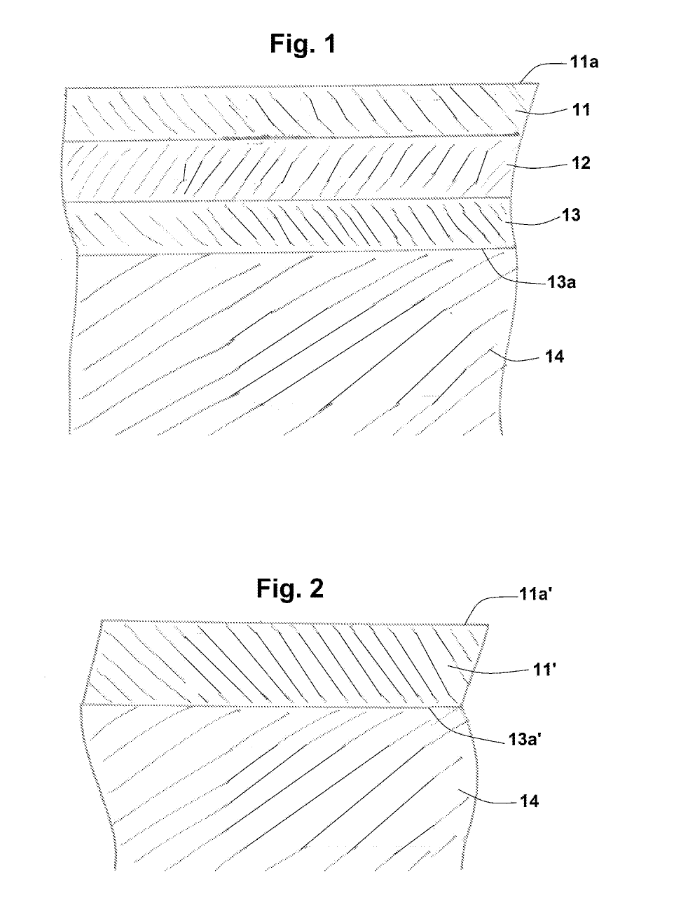

As seen in FIG. 1 a three-layer film having a total thickness of 75 μm and a symmetrical layer construction is coextruded in three layers 11, 12, and 13. The first and second outer layers 11 and 13 form first and second outer faces 11a and 13a and each have a thickness of 22.5 μm and contain, as a polymer base substance, 82 wt.-% of a low-density polyethylene (LDPE). A core layer 12 that is between the outer layers 11 and 13 has a thickness of 30 μm and comprises, as a polymer base substance, a mixture of 45% medium-density polyethylene obtained using metallocene catalysts (mMDPE) and 37 wt.-% medium-density polyethylene (LDPE). All layers 11-13 contain 12 wt.-% white batch Ampercat White PE MB 11989-I and 6 wt.-% laser master batch Treffert HAT-MB PE 91131 LSA. The second outer face 13a is intended to be secured, for instance by an adhesive, to an object or substrate 14.

FIG. 2 shows a monofilm with a single layer 11′ forming a first or inner face 13a′ secured to the object 14 and a second or outer face 11a′ that is exposed.

According to a second embodiment according to the invention, the fraction of the laser master batch is reduced to 3 wt.-%, and the fraction of LDPE in the outer layers is increased accordingly. With otherwise identical formula, 45 wt.-% LDPE and 40 wt.-% LLDPE is provided as the polymer base substance of the core layer.

According to a first comparative example, all film layers are formed from 88 wt.-% PE and 12 wt.-% white batch, and no laser master batch is used, however. According to a second comparative example, proceeding from polyethylene as the base substance for the three film layers at a fraction of 97 wt.-%, the mentioned laser master batch is contained in each film layer at a fraction of 3 wt.-%.

Table 1 below details the ability to cut the various surface-protection films using an Nd:YAG laser at a wavelength of 1064 nm and using a CO₂ laser at a wavelength of 10.6 μm. While all films can be cut well using a CO₂ laser, only the films according to the invention according to Example 1 and Example 2 can also be cut well or very well in near infrared at a wavelength of 1064 nm, so that only these films are suitable for universal usage.

TABLE 1

| | | | Comparative | Comparative |
|---|---|---|---|---|
| | Example 1 | Example 2 | Example 1 | Example 2 |
| Nd:YAG 1064 nm | 1 | 2 | — | — |
| CO2 10.6 μm | 0 | 0 | 1 | 2 |

For comparison of the brightness values of the surface-protection films according to the invention, the two surface-protection films according to Example 1 and Example 2 are compared to known surface-protection films according to the prior art.

Comparative Example 3 relates to a known surface-protection film having a light side and a dark side, as is known from EP 2 679 332 A1. The surface-protection film has a first outer layer 11 having 90% LDPE, 9% of a black batch containing carbon black, and the remainder processing aids. The layer thickness of the first outer layer 11 is 27 μm. A further film layer that forms a core layer, is formed from 45 wt.-% LDPE, 40 wt.-% LLDPE, and 15 wt.-% white batch. The second outer layer 13 that is visible during use, is formed from 86.5 wt.-% LDPE, 12.5 wt.-% white batch, and the remainder processing aids.

Comparative Example 4 relates to a three-layer coextruded surface-protection film having a dark side and a light side, and the first outer layer 11 that is provided for adherence to an object, is formed from 91 wt.-% LDPE, 8 wt.-% black batch, and 1 wt.-% processing aid. The thickness is 31.5 μm. A core layer, also having a thickness of 31.5 μm, is formed from 40 wt.-% LDPE, 40 wt.-% LLDPE, 12 wt.-% white batch, and 8 wt.-% black batch, and this core layer can absorb laser radiation in the near infrared due to the addition of carbon black, but is lightened by the addition of white batch. The second outer layer 13 that is visible during use, is formed from 85 wt.-% LDPE, 12 wt.-% white batch, and the remainder processing aids.

The comparative Example 5 relates to a three-layer surface-protection film that does not have carbon black as a component of a black batch and also cannot be cut in the near infrared using laser radiation. The first outer layer 11 that is provided for the arrangement on an object, comprises 91.5 wt.-% LDPE, 6 wt.-% white batch, and the remainder processing aids, and the thickness is 33 μm. A core layer having a thickness of 30 μm is formed from 46 wt.-% LDPE, 40 wt.-% LLDPE, 13 wt.-% white batch, and the remainder processing aids or UV stabilizers. The second outer layer 13 contains 95 wt.-% LDPE, 4 wt.-% white batch, and the remainder processing aids.

The brightness and color values determined according to CIE 1976 L* a* b* color space are listed in Table 2 (cf. DIN EN ISO 11664-4: 2011-07), and the determination was performed at a measurement angle of 10° and a CIE standard illumination D65. In all embodiments, a white underlay was selected for the film to take into consideration possible showing through.

TABLE 2

| | First outer layer 11 | | | Second outer layer 13 | | |
|---|---|---|---|---|---|---|
| | L* | a* | b* | L* | a* | b* |
| Example 1 | 94.58 | 0.08 | 2.04 | 94.51 | 0.09 | 2.07 |
| Example 2 | 95.60 | 0.22 | 1.46 | 95.55 | 0.23 | 1.47 |
| Comparative | 8.78 | −0.24 | 0.14 | 84.46 | −1.78 | −4.32 |
| Example 3 | | | | | | |
| Comparative | 8.42 | −0.24 | 0.04 | 76.24 | −2.3 | −6.31 |
| Example 4 | | | | | | |
| Comparative | 96.36 | 0.39 | 1.11 | 96.41 | 0.4 | 1.07 |
| Example 5 | | | | | | |

The known surface-protection films according to comparative Examples 3 and 4 are dark on the first outer layer 11 thereof due to the addition of black batch and have a brightness value L* of 8 to 9. Although the second outer layer 13 is white, a brightness value of only approximately 84 or 76 results there.

The surface-protection film according to comparative Example 5 has a high brightness value on both outer sides, but cannot be cut in the near infrared using a laser.

The surface-protection films according to the example according to Example 1 and Example 2 have a brightness value L* on the second outer layer 13 of greater than 94, and there is also essentially no color shift

We claim:

1. A surface-protection film comprising:
a first outer face normally applied to an object;
a first outer layer including titanium-dioxide particles, 0 wt.-% to 0.05 wt.-% carbon black, and an additive absorbent in the near infrared; and
a second outer face opposite the first outer face and having a brightness value L* of greater than 85 at a measurement angle of 10° and a CIE standard illumination D65.

2. The surface-protection film defined in claim 1, wherein an absolute value of color values a* and b* is less than 5 at a measurement angle of 10° and a CIE standard illumination D65.

3. The surface-protection film defined in claim 1, wherein the film has a total thickness between 40 μm and 150 μm.

4. The surface-protection film defined in claim 1, wherein the first film layer is comprised mainly of polyethylene.

5. The surface-protection film defined in claim 1, further comprising a second film layer laminated to the first film layer and comprising
a white batch containing titanium dioxide (TiO₂), and
0 wt.-% to 0.05 wt.-% carbon black.

6. The surface-protection film defined in claim 1, further comprising:
a third layer.

7. The surface-protection film defined in claim 5, wherein the fraction of titanium dioxide is between 3 wt.-% and 12 wt.-% in at least one of the first and second film layers.

8. The surface-protection film defined in claim 1, wherein, in at least one of the first and second film layers, the weight fraction of the titanium dioxide particles relative to a total quantity of the titanium dioxide a particle size standardized to a volume-equivalent ball diameter between 400 nm and 700 nm, is greater than 50%.

9. The surface-protection film defined in claim 1, wherein at least the first film layer contains inorganic particles between 1 wt.-% and 5 wt.-% as a component of an absorbent additive.

10. The surface-protection film defined in claim 9, wherein mica coated with metal oxide is provided as particles.

11. The surface-protection film defined in claim 5, wherein the first and second layers are formed from polyethylene, the white batch containing titanium dioxide, and an additive absorbent in the near infrared that is free of carbon black.

12. Use of a surface-protection film according to claim 1 for the temporary protection of an object during the processing thereof according to the following consecutive steps:
applying the surface-protection film with the first outer face on at least one section of the object such that the second face is exposed;
inpinging on the exposed second outer face of the surface-protection film by laser radiation having a wavelength in the near or moderate infrared; and
cutting the surface-protection film and the object arranged underneath by the laser radiation.

13. The use defined in claim 12, wherein the object is a metal plate.

14. The use defined in claim 12, wherein the object is provided with openings and/or an external contour by the laser radiation.
